(19) United States
(12) Patent Application Publication
(10) Pub. No.: US 2010/0033575 A1
(43) Pub. Date: Feb. 11, 2010

(54) EVENT SURVEILLANCE SYSTEM AND METHOD USING NETWORK CAMERA

(75) Inventors: Chung-ho LEE, Daejeon (KR); Yong Joon LEE, Daejeon (KR); Ju Wan KIM, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/342,519

(22) Filed: Dec. 23, 2008

(30) Foreign Application Priority Data
Aug. 11, 2008 (KR) 10-2008-0078540

(51) Int. Cl. H04N 7/18

(52) U.S. Cl. 348/159; 348/E05.022

(57) ABSTRACT

An event surveillance system includes: a network camera for monitoring real-time video images to perform event tracking on an event occurred therein; and at least one machine-to-machine agent, connected to the network camera and devices in a network, for providing protocols for data communications between the network camera and the devices. If the machine-to-machine agent receives information on the event occurred in the network camera, the machine-to-machine agent requests the devices to provide event information for use in verifying accuracy of the event and verifies the accuracy of the event based on the event information provided by the devices. The network camera monitors in real time the event verified to be accurate.

### CROSS-REFERENCE(S) TO RELATED APPLICATION(S)

The present invention claims priority of Korean Patent Application No. 10-2008-0078540, filed on Aug. 11, 2008, which is incorporated herein by reference.

### FIELD OF THE INVENTION

The present invention relates to an event surveillance system and method using a network camera; and, more particularly, to an event surveillance system and method capable of accurately extracting various occurrent or occurrable events via autonomous cooperation between a network camera and devices in various networks.

### BACKGROUND OF THE INVENTION

Conventional video surveillance systems, e.g., a CCTV (Closed-circuit Television) system, include CCD (Charge-Coupled Device) cameras for converting surveillance objects into electrical signals and a video signal switcher, i.e., a matrix switcher, for displaying the signals from the CCD cameras on monitors.

The conventional CCTV systems have been utilized for a simple surveillance control, e.g., surveilling an intruder into a building, a factory, a parking lot and the like. That is, purposes of the CCTV systems have been limited to intrusion surveillance and criminal prevention.

In recent, the CCTV systems evolve to employ electronic still cameras and network cameras capable of communicating with computers. Specifically, network cameras introduced recently embed therein a web server, a storage, an intelligent image processor, an intelligent event handler and the like, to thereby provide additional services, e.g., a real-time video conference, motion detection, sound detection, object detection and tampering alarm for autonomously generating an alarm signal on occurrence of an intentional obstruction in video monitoring. Such network cameras store video data at an occurrence time of an event and provide the video data to a server in a network, thereby supporting surveillance functions efficiently.

However, a conventional surveillance system using the network camera has drawbacks in that type of events extractible by a single camera is restricted and accuracy of occurred event can be significantly lowered when the camera is installed outdoor to be thereby exposed to various outdoor environmental factors, e.g., weather, shades, noises and the like, to be considered.

### SUMMARY OF THE INVENTION

In view of the above, the present invention provides an event surveillance system and method using a network camera, in which event information is shared with devices, adjacent to the network camera, in various networks to improve event accuracy, e.g., motion detection, object tracking and the like.

Further, the present invention provides an event surveillance system and method capable of accurately extracting various events via autonomous cooperation between a network camera and devices in various networks.

In accordance with one aspect of the present invention, there is provided an event surveillance system, including:

a network camera for monitoring real-time video images to perform event tracking on an event occurred therein; and

at least one machine-to-machine agent, connected to the network camera and devices in a network, for providing protocols for data communications between the network camera and the devices;

wherein, if the machine-to-machine agent receives information on the event occurred in the network camera, the machine-to-machine agent requests the devices to provide event information for use in verifying accuracy of the event and verifies the accuracy of the event based on the event information provided by the devices; and

wherein the network camera monitors in real time the event verified to be accurate.

In accordance with another aspect of the present invention, there is provided an event surveillance method in a system having a network camera and devices adjacent to the network camera in various networks, the method including:

requesting the devices to provide event information for use in verifying accuracy of an event occurred in the network camera;

determining whether the event information provided by the devices are associated with the event occurred in the network camera;

verifying the accuracy of the event based on the event information provided by the devices;

registering, if the event is verified to be accurate, the event along with the event information associated with the event occurred in the network camera; and

monitoring the registered event in real time via the network camera and the devices.

According to the present invention, devices adjacent to a network camera in various networks are utilized to diversify type of extractible events and improve event accuracy. In particular, the event accuracy in case of a network camera easily affected by various outdoor environmental factors, e.g., a network camera installed outdoor or installed at a transportation means, can be greatly improved.

### BRIEF DESCRIPTION OF THE DRAWINGS

The above features of the present invention will become apparent from the following description of embodiments, given in conjunction with the accompanying drawings, in which:

FIG. 1 illustrates an event surveillance system in accordance with an embodiment of the present invention;

FIG. 2 illustrates a block diagram of each machine-to-machine agent of FIG. 1;

FIG. 3 illustrates a flowchart of an event surveillance procedure in accordance with the embodiment of the present invention; and

FIG. 4 illustrates an exemplary view of the event surveillance procedure using RFID tag information in accordance with the embodiment of the present invention.

### DETAILED DESCRIPTION OF THE EMBODIMENTS

Hereinafter, embodiments of the present invention will be described in detail with reference to the accompanying drawings, which form a part hereof.

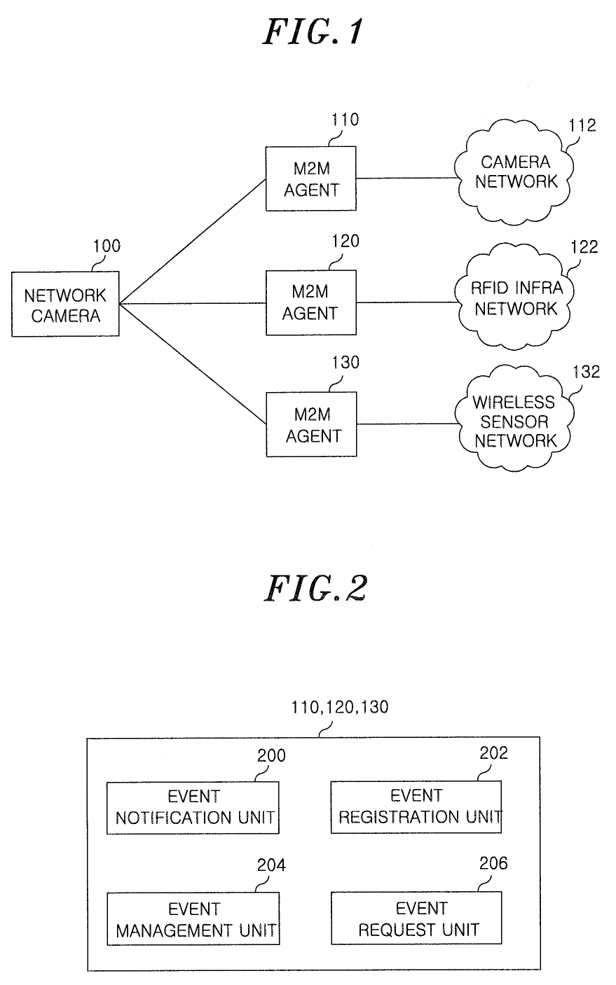

FIG. 1 illustrates an event surveillance system in accordance with an embodiment of the present invention.

As shown in FIG. 1, the event surveillance system includes a network camera 100 and machine-to-machine (hereinafter, simply referred to as “M2M”) agents 110, 120 and 130.

The network camera 100 performs real-time video monitoring and event tracking by using a web server, a storage, an intelligent image processor, an intelligent event handler and the like, which are embedded in the network camera 100. The network camera 100 continues the event tracking only if the event is verified to be accurate via the M2M agents 110, 120 and 130.

The M2M agents 110, 120 and 130 are connected to the network camera 100 and devices (not shown) in a camera network 112, an RFID (radio-frequency identification) infra network 124 and a wireless sensor network 134, respectively.

The M2M agents 110, 120 and 130 may be installed separately from the network camera 100 as shown in FIG. 1, and also, may be installed at the network camera 100 and network devices, e.g., gateways, connecting the network camera 100 and the networks 112, 122 and 132, respectively, on function basis.

When an event, e.g., movement of a specific person, occurs in the network camera 100, the M2M agents 110, 120 and 130 respectively request the devices in the networks 114, 124 and 134 to provide event information associated with the event occurred in the network camera 100. Then, each of the M2M agents 110, 120 and 130 verifies accuracy of events occurred in the network camera 100 based on the event information provided by the devices in the networks 114, 124 and 134, respectively.

To be specific, accuracy of the event occurred can be verified by checking the movement of a specific person via other cameras in the camera network 112, verifying a user in the RFID infra network 122 and checking a location and moving time of the user based on RFID tag information attached to a device of the user and checking sensing information via various sensors in the wireless sensor network 132. Further, various additional information on the event can be provided to the network camera 100 by the devices in the networks 112, 122 and 132.

The M2M agent 110 connects cameras in the camera network 112 to the network camera 100, to thereby build an organic surveillance system between the network camera 100 and other cameras adjacent thereto and increase the event accuracy. That is, if an object detected by the network camera 100 is also detected by a camera in the camera network 112, the M2M agent 110 receives information on the object from the camera and provides the information to the network camera 100, thereby allowing verification of the event.

The M2M agent 120 connects RFID readers in the RFID infra network 122 to the network camera 100. For example, if a person or an object to which an RFID tag is attached approaches an RFID reader in the RFID infra network 122, the RFID reader reads RFID tag information from the RFID tag and transmits the RFID tag information to the M2M agent 120. Then, the M2M agent 120 integrates the RFID tag information to verify the accuracy of the event based thereon.

The RFID tag information may be transmitted from the RFID readers to the M2M agent 120 in real-time or in response to a request from the M2M agent 120, and may be managed in the M2M agent 120 on bases of occurrence time, occurrence location and the like.

The M2M agent 130 connects sensors and actuators in the wireless sensor network 132 to the network camera 100. The sensors and actuators in the wireless sensor network 132 collect sensor information and actuator information, respectively and transmit the information to the M2M agent 130. The M2M agent 130 totals the collected information and generates summarized information to verify the accuracy of the event.

Here, each of the sensors in the wireless sensor network 132 may be at least one of a temperature sensor, a humidity sensor, an impact detecting sensor, a vibration detecting sensor and a machine-driving detecting sensor.

As described above, in order to integrate the network camera 100 with various devices adjacent to the network camera 100, the devices in the networks 112, 122 and 132 provide the event information to the M2M agents 110, 120 and 130, respectively. Here, the event information may include at least one of an event name, a sensor/driving-machine name, an event type, an event location, event accuracy, an event occurrence period and an event occurrence time.

With the above-described configuration, the event surveillance system of FIG. 1 allows a terminal, i.e., the network camera 100, to perform expensive surveillance functions which have been performed only by a server in the past.

Below, the M2M agents 110, 120 and 130 of FIG. 1 will be described in detail with reference to FIG. 2.

FIG. 2 illustrates a block diagram of each M2M agent of FIG. 1.

The M2M agents 110, 120 and 130 provides M2M protocols to autonomously and dynamically integrate the network camera 100 with various devices in the camera network 112, the RFID infra network 122 and the wireless sensor network 132, respectively. To be specific, the M2M agents 110, 120 and 130 notify information on an event occurred in the network camera 100 and request, receive, register and manage event information associated with the event occurred in the network camera 100.

As shown in FIG. 2, each of the M2M agents 110, 120 and 130 includes an event notification unit 200 and an event registration unit 202, an event management unit 204 and an event request unit 206.

The event notification units 200 of the M2M agents 110, 120 and 130 provide information on an event occurred in the network camera 100 to the devices in the network 112, 122 and 132, respectively. Here, the information may be provided to the devices in a form of meta-information.

The event registration units 202 of the M2M agents 110, 120 and 130 receive the event information provided by the devices in the network 112, 122 and 132, respective, to register the event information to internal database thereof.

The event management units 204 of the M2M agents 110, 120 and 130 analyze availability of the devices in the network 112, 122 and 132, respective, and verify accuracy of the event occurred in the network camera 100.

The event request units 206 of the M2M agents 110, 120 and 130 request, under the control of the event management units 200, the devices in the network 112, 122 and 132, respectively to provide the event information. For example, in order to verify movement direction of an object when an object tracking event for the object occurs in the network camera 100, the event management unit 204 of the M2M agents 110, 120 and 130 analyze availability of the cameras in the camera network 112, the RFID readers in the RFID infra network 122 and the sensors and actuators in the wireless sensor network 132, respectively, and, the event request units 206 204 of the M2M agents 110, 120 and 130 request the devices to provide the event information.

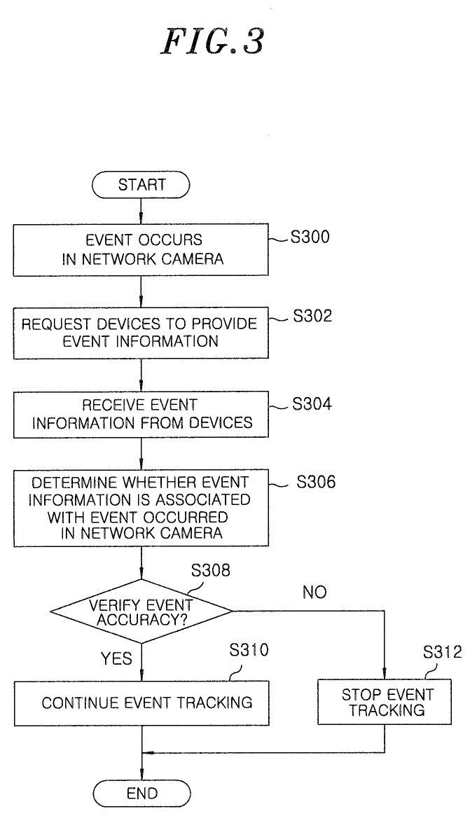

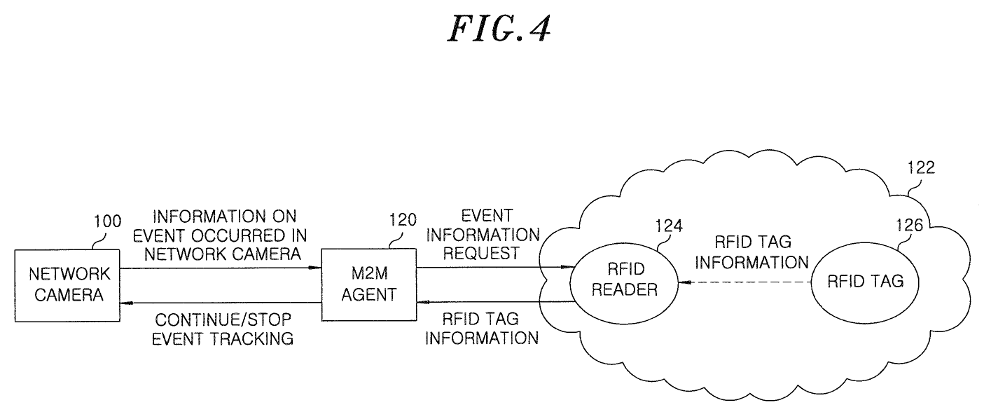

FIG. 3 illustrates a flowchart of an event surveillance procedure in accordance with the embodiment of the present invention.

First, an event, e.g., detecting a moving object, tracking an object or the like, occurs in the network camera 100 and the M2M agent 110, 120 and 130 receives information on the event occurred in the network camera 100 (step S300). After that, the M2M agents 110, 120 and 130 request devices in the network 112, 122 and 132, respectively, to provide event information for use in verification of the event (step S302).

The devices in the network 112, 122 and 132 transmit to the M2M agent 110, 120 and 130, respectively, the event information (step S304).

The M2M agent 110, 120 and 130 compare and analyze, via the event management units 204, the event occurred in the network camera 100 and the event information provided by the devices in the network 112, 122 and 132, respectively, thereby determining whether each event information is associated with the event occurred in the network camera 100. (step S306).

After that, the M2M agent 110, 120 and 130 determine whether or not at least one event information associated with the event occurred in the network camera 100 is provided by the devices in the networks 112, 122 and 132, respectively (step S308). If it is determined in the step S308 that the event information associated with the event occurred in the network camera 100 is not provided by the devices adjacent to the network camera 100, i.e., if it is determined that the event occurs only in the network camera 100, the information on the event occurred in the network camera 100 is regarded as wrong information and stops the event tracking (step S312). Afterwards, the network camera 100 checks occurrence of events via real-time surveillance.

If it is determined in the step S308 that the event information associated with the event occurred in the network camera 100 is provided by the devices adjacent to the network camera 100, the network camera 100 continues the event tracking (step S310). While the event tracking, the M2M agents 110, 120 and 130 register, via the event registration units 202, the event information associated with the event occurred in the network camera 100 in real time.

In the above-described procedure, the event accuracy can be determined to be high when the network camera 100 receives from the neighboring devices one or more event information of other types, e.g., camera image information, sensor information, RFID tag information and the like, associated with the event occurred in the network camera 100. Accordingly, the event accuracy can be set to be evaluated based on the number of event information of other types received by the network camera 100.

Through the above-described procedure, event accuracy on an event occurred in the network camera 100 can be improved and various types of information on the event can be extracted.

FIG. 4 illustrates an exemplary view of the event surveillance procedure using RFID tag information in accordance with the embodiment of the present invention.

As shown in FIG. 4, if an event, e.g., tracking a person moving left to right, occurs in the network camera 100, the network camera 100 transmits information on the event occurred therein to the M2M agent 120.

The M2M agent 120 requests an RFID reader 124 in the RFID infra network 122 to provide event information for use in verification of the event.

In response to the event information request, the RFID reader 124 transmits RFID tag information read from an RFID tag 126 in the RFID infra network 122.

To be specific, if the M2M agent 120 receives the information on the event occurred in the network camera 100 and the RFID tag information read from the RFID tag 128 adjacent to the network camera 100, the M2M agent 120 can determine whether or not the RFID tag information is associated with the event occurred in the network camera 100 by comparing moving direction information of the person in the information received from the network camera 100 and a location and time information in the RFID tag information.

If it is determined that the RFID tag information is associated with the event occurred in the network camera 100, the M2M agent 120 determines that the event is verified to be accurate. Depending on the verification result, the network camera 100 continues or stops the event tracking, which increases the event accuracy.

While the invention has been shown and described with respect to the embodiments, it will be understood by those skilled in the art that various changes and modification may be made without departing from the scope of the invention as defined in the following claims.

What is claimed is:

1. An event surveillance system, comprising:
a network camera for monitoring real-time video images to perform event tracking on an event occurred therein; and
at least one machine-to-machine agent, connected to the network camera and devices in a network, for providing protocols for data communications between the network camera and the devices;
wherein, if the machine-to-machine agent receives information on the event occurred in the network camera, the machine-to-machine agent requests the devices to provide event information for use in verifying accuracy of the event and verifies the accuracy of the event based on the event information provided by the devices; and
wherein the network camera monitors in real time the event verified to be accurate.

2. The system of claim 1, wherein the machine-to-machine agent verifies the event to be accurate if at least one device in the network provides the event information associated with the event occurred in the network camera.

3. The system of claim 1, wherein the event information includes at least one of movement detection information, movement tracking information, sensor information, location information and time information of an object.

4. The system of claim 1, wherein the devices include at least one of cameras in a camera network, radio-frequency identification readers in a radio-frequency identification infra network and sensors and actuators in a wireless sensor network.

5. The system of claim 4, wherein the sensors include at least one of temperature sensors, humidity sensors, impact detection sensors, vibration detection sensors and machine-driving detection sensors.

6. The system of claim 1, wherein the machine-to-machine agent includes:
an event notification unit for providing the devices of the information on the event occurred in the network camera;
an event management unit for verifying the accuracy of the event based on the event information provided by the devices;
an event request unit for requesting, under a control of the event management unit, the devices to provide the event information; and
an event registration unit for registering the event occurred in the network camera along with the event information provided by the devices, on bases of occurrence time, occurrence location and types of the event.

7. The system of claim 6, wherein the types of the event are classified on bases of devices providing the event information and types of the event information.

8. The system of claim 1, further comprising:
machine-to-machine agents, each of which is connected to the network camera and devices in a network, for providing protocols for data communications between the network camera and the devices;
wherein, if each of the machine-to-machine agents receives information on the event occurred in the network camera, the machine-to-machine agent requests the devices connected thereto to provide event information for use in verifying accuracy of the event and verifies the accuracy of the event based on the event information provided by the devices.

9. The system of claim 8, wherein each of the machine-to-machine agents verifies the event to be accurate if at least one device connected thereto provides the event information associated with the event occurred in the network camera.

10. The system of claim 9, wherein each of the machine-to-machine agent includes:
an event notification unit for providing the devices of the information on the event occurred in the network camera;
an event management unit for verifying the accuracy of the event based on the event information provided by the devices;
an event request unit for requesting, under a control of the event management unit, the devices to provide the event information; and
an event registration unit for registering the event occurred in the network camera along with the event information provided by the devices, on bases of occurrence time, occurrence location and types of the event.

11. An event surveillance method in a system having a network camera and devices adjacent to the network camera in various networks, the method comprising:
requesting the devices to provide event information for use in verifying accuracy of an event occurred in the network camera;
determining whether the event information provided by the devices are associated with the event occurred in the network camera;
verifying the accuracy of the event based on the event information provided by the devices;
registering, if the event is verified to be accurate, the event along with the event information associated with the event occurred in the network camera; and
monitoring the registered event in real time via the network camera and the devices.

12. The method of claim 11, wherein the network camera monitors real-time video images to perform event tracking on the event occurred therein.

13. The method of claim 11, wherein the event is verified to be accurate if at least one device in the networks provides the event information associated with the event occurred in the network camera.

14. The method of claim 11, wherein the event information are registered on bases of occurrence time, occurrence location and types of the event.

15. The method of claim 14, wherein the types of the event are classified on bases of devices providing the event information and types of the event information.

16. The method of claim 11, wherein the system further includes a machine-to-machine agent, connected to the network camera and the devices, for providing protocols for data communications between the network camera and the devices.

17. The method of claim 16, wherein the machine-to-machine agent converts the information on the event occurred in the network camera into meta-information to provide the meta-information to the devices.

18. The method of claim 11, wherein the event information includes at least one of movement detection information, movement tracking information, sensor information, location information and time information of an object.

19. The method of claim 11, wherein the devices include at least one of cameras in camera networks, radio-frequency identification readers in radio-frequency identification infra networks and sensors and actuators in wireless sensor networks.

20. The method of claim 19, wherein the sensors include at least one of temperature sensors, humidity sensors, impact detection sensors, vibration detection sensors and machine-driving detection sensors.
